(19) United States
(12) Patent Application Publication
(10) Pub. No.: US 2019/0026453 A1
(43) Pub. Date: Jan. 24, 2019

(54) POLYHEDRAL THREE-DIMENSIONAL IMAGING DEVICE FOR SIMULTANEOUSLY AUTHENTICATING FINGERPRINT AND FINGER VEINS

(71) Applicant: ALL IT TOP CO., LTD., SEOUL (KR)

(72) Inventors: Sung Ho CHOI, Uiwang-si (KR); Chung Ja SONG, Uiwang-si (KR)

(21) Appl. No.: 16/093,763

(22) PCT Filed: Apr. 4, 2017
(86) PCT No.: PCT/KR2017/003666

§ 371 Date: Oct. 15, 2018

(30) Foreign Application Priority Data
Apr. 15, 2016 (KR) 10-2016-0046122
Oct. 5, 2016 (KR) 10-2016-0128071

(51) Int. Cl. G06F 21/32; G06K 9/00; H04L 9/32

(52) U.S. Cl. CPC G06F 21/32; G06K 9/00013; H04N 13/20; G06K 9/00885; H04L 9/3231

(57) ABSTRACT

Provided is a polyhedral three-dimensional imaging device for simultaneously authenticating fingerprint and finger veins having an integrated imaging and authenticating device for capturing images of fingerprint and finger veins. An object accommodation unit includes on the top and bottom an upper scanning panel case, which forms a finger mounting portion, and a lower scanning panel case which accommodates the full length part of the upper scanning panel case. A scanning panel, which is for simultaneously capturing images of fingerprint and finger veins, is provided on the upper part of the upper scanning panel case. The scanning panel has on the front and back a fingerprint finger-contact portion and a finger vein finger-non-contact portion forming a step.

### CROSS-REFERENCE TO RELATED APPLICATIONS

This application claims priority to PCT/KR2017/003666, having a filing date of Apr. 4, 2017, which is based on Korean Patent Application No. 10-2016-0046122, having a filing date of Apr. 15, 2016 and Korean Patent Application No. 10-2016-0128071, having a filing date of Oct. 5, 2016, the entire contents all of which are hereby incorporated by reference.

### FIELD OF TECHNOLOGY

Thefollowing relates to a polyhedral stereoscopic imaging device for simultaneously authenticating a fingerprint and finger veins, and more particularly, to a polyhedral stereoscopic imaging device for simultaneously authenticating a fingerprint and finger veins that has been devised to be applied to the National Intelligence Service and financial transaction systems that require extremely high security.

The polyhedral stereoscopic fingerprint and finger vein imaging and authentication device is a technology of a device that further authenticates finger veins in addition to fingerprints using two fingers so that uniqueness of an individual's biometric information is better maintained than in a conventional authentication environment, thereby securing a new financial technology (fintech).

### BACKGROUND

Biometric information that is unique to each individual has an advantage in that it cannot be separated from each individual.

In the case of fingerprint recognition, frequent authentication errors such as those in a case in which a finger is wet or stained with a foreign substance or a case in which finger skin is damaged or deformed have been pointed out, and there has been a problem in that a fingerprint surface is easy to forge or duplicate.

A false acceptance rate of fingerprint recognition is about 5%. For example, about five out of a hundred fingerprints are falsely accepted.

Meanwhile, in the iris recognition technology, recognition fails or takes a large amount of time in cases in which one is wearing color contact lenses or has received Laser-Assisted In-Situ Keratomileusis (LASIK) surgery or Laser-Assisted Sub-Epithelial Keratectomy (LASEK) surgery, and a problem in that an error may occur depending on a distance and an angle has been pointed out.

A finger vein authentication technology has been known as biometric information that is superior in terms of all aspects such as resistance to forgery and falsification, false acceptance rate, false rejection rate, failure to enroll rate, and authentication time as compared to the above-mentioned biometric technologies.

The finger vein authentication technology is a technology in which vein patterns are recognized by transmitting near infrared light through a finger. The finger vein authentication technology has advantages in that forgery and falsification are impossible since blood vessels in fingers are authenticated and finger vein patterns of a dead person may be utilized when necessary.

In the finger vein authentication technology, a hardware device technology in which a finger vein image is obtained using a charge-coupled-device (CCD) camera and a software technology in which a finger vein image is filtered or vein patterns are extracted from a finger vein image and computed using a pattern processing program are combined.

However, a finger vein authentication device has two weaknesses, one of which is that there is still a possibility of false acceptance. It has been known that the same finger vein pattern is recognized from one per a hundred thousand people or one per a million people according to a finger vein processing algorithm. Therefore, despite the superiority of the finger vein authentication technology, there has been a weakness in that accurate user authentication cannot be performed by using only the finger vein patterns in the case of two people whose two-dimensional finger vein patterns in fingers are similar by chance.

The second weakness is that, when comparing similarities between two finger vein images, the comparison should be performed after superimposing the two finger vein images so that two finger vein patterns almost exactly overlap each other. That is, since similarities between blood vessels of two finger vein patterns are determined on the basis of relative coordinates instead of absolute coordinates, this may act as a deviation factor that hinders accurate recognition.

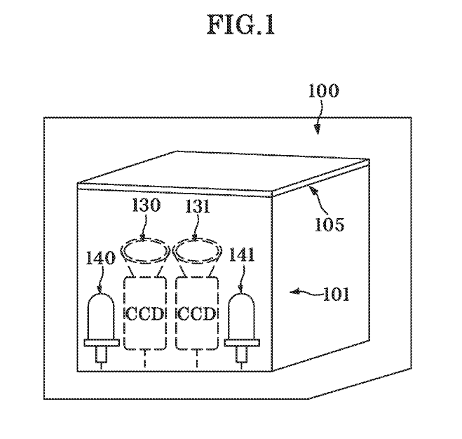

To solve such problems, a technology illustrated in FIG. 1 has been devised.

As seen in FIG. 1, a scan panel which is formed of a transparent material such as glass or acryl is provided at an upper portion of an object accommodating portion. A user places a finger object on the scan panel to start finger vein authentication. Upon start of finger vein authentication by the device, an infrared light source portion and a visible light source portion irradiate the finger object with infrared light and visible light.

Then, a CCD infrared camera and a CCD visible light camera respectively capture images of finger veins and knuckle fingerprints which have been irradiated with the infrared light and visible light.

In a device of the known art, two CCD cameras are embedded.

A finger vein camera is provided by being embedded in the object accommodating portion and captures an image of finger veins of the object toward the scan panel. In addition, almost simultaneously, a knuckle fingerprint camera, which is provided in the same object accommodating portion, captures an image of knuckle fingerprints of the object.

The infrared light source portion radiates infrared light toward the object accommodating portion. Preferably, the infrared light source portion may include one or more light emitting diodes (LEDs) and emit infrared light having a wavelength of 630 to 1,000 nm that is suitable for capturing a finger vein image. In addition, preferably, an optical filter may be provided in the infrared light source portion and eliminate optical noise.

The visible light source portion radiates visible light toward the object accommodating portion. The visible light source portion may include one or more LEDs and emit ultraviolet light having a wavelength suitable for capturing an image of knuckle fingerprints on a surface of a finger.

In addition, in an exemplary embodiment of the known art, a single infrared light source portion configured to radiate infrared light toward the object accommodating portion and a single visible light source portion configured to radiate visible light toward the object accommodating portion may be provided.

Further, in a preferred embodiment of the known art, the finger vein camera acquires finger vein images of two finger objects.

However, even when authentication is performed by a finger vein authentication device using two fingers, the possibility of false acceptance, which is the first weakness, and the problem in that, when comparing similarities between two finger vein images, the two finger vein images should be compared after superimposing the two finger vein images so that two finger vein patterns almost exactly overlap each other, which is the second weakness, still exist, and there is also a problem in that it is not possible to cover a false acceptance rate of only one finger vein pattern.

Furthermore, the finger vein authentication technology has been known as biometric information that is superior in terms of all aspects such as resistance to forgery and falsification, false acceptance rate, false rejection rate, failure to enroll rate, and authentication time as compared to the above-mentioned biometric technologies. The finger vein authentication technology is a technology in which vein patterns are recognized by transmitting near infrared light through a finger. The finger vein authentication technology has advantages in that forgery and falsification are impossible since blood vessels in fingers are authenticated and finger vein patterns of a dead person may be utilized. However, there is a problem in that one per ten million or more people may have the same finger vein pattern.

### SUMMARY

An aspect relates to an authentication method capable of significantly improving a false acceptance rate of finger veins, decreasing a false acceptance rate of fingerprints by simultaneously authenticating fingerprints and finger veins, decreasing errors in determining similarities between blood vessels of finger veins, and easily authenticating human body information of a person even by using only one finger.

Further, embodiment of the present invention are to increase an authentication determination speed and facilitate manufacture of authentication determination equipment in a case in which separate recognition rates of fingerprints and finger veins are decreased to narrow an error range related to the finger print recognition rate or finger vein recognition rate and whether a user is authenticated is determined from a combination of fingerprints and finger veins.

To achieve the above-described embodiments of the present invention, one aspect of embodiments of the present invention provides a polyhedral stereoscopic imaging device that simultaneously authenticates fingerprints and finger veins, the polyhedral stereoscopic imaging device including: a groove sidewall (251) formed around a periphery of a finger vein finger non-contact portion (250b) of a scan panel (250) so that the finger vein finger non-contact portion (250b) is formed as a groove; a finger mounting portion (252) formed in parallel with a fingerprint finger contact portion (250a) so that a finger is allowed to be placed around an upper edge of the finger vein finger non-contact portion (250b); and three charge-coupled-device (CCD) cameras (220, 230, 231) configured to capture images of fingerprints and finger veins, wherein finger vein cameras (230)(231) are embedded in an object accommodating portion (201) and capture images of finger veins of an object toward the scan panel (250) from below and beside the scan panel (250), and a fingerprint camera (220) captures an image of a fingerprint of the object from therebelow.

In addition, in the polyhedral stereoscopic imaging device, a temperature sensor (275) configured to detect a bloodstream temperature of a finger may be formed in front of the finger vein finger non-contact portion (250b) opposite the fingerprint finger contact portion (250a).

In addition, the polyhedral stereoscopic imaging device may be an integrated imaging and authentication device (200) capable of capturing images of fingerprints and finger veins, the integrated imaging and authentication device (200) including: an object accommodating portion (201) including a scan panel upper case (201a), which forms a finger mounting portion, formed at an upper portion and including a scan panel lower case (201b), which accommodates a full-length portion of the scan panel upper case (201a), formed at a lower portion; and a scan panel (250) provided at an upper portion of the scan panel upper case (201a) and configured to simultaneously capture images of fingerprints and finger veins, the scan panel (250) including a fingerprint finger contact portion (250a) and a finger vein finger non-contact portion (250b) formed at a front portion and a rear portion, respectively, with a height difference, wherein a groove sidewall (251) is formed around a periphery of the finger vein finger non-contact portion (250b) of the scan panel (250) so that the finger vein finger non-contact portion (250b) is formed as a groove, a finger mounting portion (252) is formed in parallel with the fingerprint finger contact portion (250a) so that a finger is allowed to be placed around an upper edge of the finger vein finger non-contact portion (250b), and a temperature sensor (275) configured to detect a bloodstream temperature of a finger is formed in front of the finger vein finger non-contact portion (250b) opposite the fingerprint finger contact portion (250a).

In addition, the polyhedral stereoscopic imaging device may be an integrated imaging and authentication device (200) capable of capturing images of fingerprints and finger veins, the integrated imaging and authentication device (200) including: an object accommodating portion (201) including a scan panel upper case (201a), which forms a finger mounting portion, formed at an upper portion and including a scan panel lower case (201b), which accommodates a full-length portion of the scan panel upper case (201a), formed at a lower portion; and a scan panel (250) provided at an upper portion of the scan panel upper case (201a) and configured to simultaneously capture images of fingerprints and finger veins, the scan panel (250) including a fingerprint finger contact portion (250a) and a finger vein finger non-contact portion (250b) formed at a front portion and a rear portion, respectively, with a height difference, wherein a groove sidewall (251) is formed around a periphery of the finger vein finger non-contact portion (250b) of the scan panel (250) so that the finger vein finger non-contact portion (250b) is formed as a groove in which an infrared light source portion (240), which is configured to transmit infrared light, is allowed to be mounted at a lower portion, a finger mounting portion (252) is formed in parallel with the fingerprint finger contact portion (250a), which has a fingerprint authentication module (250aa) formed thereon, so that a finger is allowed to be placed around an upper edge of the finger vein finger non-contact portion (250b), a set of the fingerprint finger contact portion (250a) and the finger vein finger non-contact portion (250b) is formed along each of two parallel rows in the scan panel (250) so that two fingers are allowed to be simultaneously authenticated, and any one of six authentication methods respectively having authentication factor pairs, 1) Fingerprint 1 (250an) and Fingerprint 2 (250ar); 2) Finger vein 1 (250bn) and Finger vein 2 (250br); 3) Fingerprint 1 (250an) and Finger vein 1 (250bn); 4) Fingerprint 2 (250ar) and Finger vein 2 (250br); 5) Fingerprint 1 (250an) and Finger vein 2 (250br); and 6) Fingerprint 2 (250ar) and Finger vein 1 (250bn), is selectively used to perform authentication.

In addition, in the polyhedral stereoscopic imaging device, authentication may be performed using a middleware verification processing unit only when the two authentication factors in the method selected among the six authentication methods are sequentially authenticated.

In addition, in the polyhedral stereoscopic imaging device, when information selected first in a method selected among the six authentication methods is identical or similar to another piece of information and thus user identification is not possible, authentication may be performed using a middleware verification processing unit after user authentication is performed from the same or similar piece of information by using another piece of undesignated information.

In addition, the polyhedral stereoscopic imaging device may be an integrated imaging and authentication device (200) capable of capturing images of fingerprints and finger veins, the integrated imaging and authentication device (200) including: an object accommodating portion (201) including a scan panel upper case (201a), which forms a finger mounting portion, formed at an upper portion and including a scan panel lower case (201b), which accommodates a full-length portion of the scan panel upper case (201a), formed at a lower portion; and fingerprint finger contact portions (250aa)(250ab) disposed at an upper portion of the scan panel upper case (201a) and configured to capture images of fingerprints, wherein fingerprint authentication modules (250aa)(250ab) are formed in the fingerprint finger contact portions (250aa)(250ab) of the scan panel, and the fingerprint finger contact portions (250aa)(250ab) are formed along each of two parallel rows in the scan panel by partitions (253a)(253b)(253c) that allow two fingers to be mounted on the scan panel.

In addition, in the polyhedral stereoscopic imaging device, temperature sensors (205a)(205b) configured to detect a bloodstream or temperature of a finger may be formed at lower portions of the fingerprint finger contact portions (250aa)(250ab) of the scan panel, or a thin plate layer configured to authenticate a bloodstream or temperature of a finger may be formed on any one layer of the fingerprint authentication modules (250aa)(250ab).

According to embodiments of the present invention, a false acceptance rate of finger veins can be significantly improved, a false acceptance rate of fingerprints can be decreased by simultaneously authenticating fingerprints and finger veins, errors in determining similarities between blood vessels of finger veins can be decreased, and human body information of a person can be easily authenticated even by using only one finger. Therefore, high security capable of replacing an accredited certificate can be achieved.

Therefore, even when two fingers are used, an error range related to a fingerprint recognition rate or a finger vein recognition rate is decreased such that separate recognition rates of fingerprints and finger veins are decreased and whether a user is authenticated is determined using a combination of fingerprints and finger veins. In this way, an authentication determination speed can be increased, manufacture of authentication determination equipment can be facilitated, and an error range can be significantly decreased.

When the above-mentioned advantages and weaknesses are complemented and biometric information is acquired through a four dimensional (4D) stereoscopic authentication device in which a finger vein authentication technology and a fingerprint authentication technology are combined that simultaneously scans fingerprints and finger veins of two fingers, uniqueness of one's biometric information is expected to be maintained until the end of the world.

In a fingerprint and finger vein imaging and authentication device, a fingerprint acquisition module is provided at the front ⅓ portion of an upper end portion at which a finger is authenticated, and a finger vein acquisition module is provided from a first knuckle behind the front ⅓ portion to an inner portion of a second knuckle. After fingerprint and finger vein information of a user is acquired, the acquired information is formed into a database. At the moment at which an index finger and a middle finger or a middle finger and a ring finger, which form a double “I” shape or form a V-shape together due to partition portions formed according to interference of infrared light transmitted from below, are naturally brought into contact with a terminal, the fingers are simultaneously authenticated using a 4D stereoscopic imaging technique. In this way, all functions of the fingerprint and finger vein imaging and authentication device are secured.

When two fingers are used as described above, since a contact angle is constant and congruity and stability of authentication portions that come into contact with the two fingers are ensured, fingerprints or finger veins can be recognized with high accuracy.

Particularly, as it is confirmed in a Google search result or a search result provided by Doopedia when “fingerprint authentication technology” is searched on Naver, the probability that one has the same fingerprint as someone else is only one in a billion. Despite the low probability, forgery and falsification problems have not been completely solved. However, in embodiments of the present invention, by a temperature sensor, which uses pulsation of bloodstream, being operated at the moment at which two parallel fingers as well as fingerprints and finger veins thereof naturally come into contact with a terminal, and the temperature sensor being used in conjunction with the technology of the 4D stereoscopic imaging device, all of the fingerprints and finger veins, which are classified into four different forms, of the two fingers are simultaneously scanned and recognized. In this way, all false acceptance and false rejection problems are eliminated.

### BRIEF DESCRIPTION

Some of the embodiments will be described in detail, with reference to the following figures, wherein like designations denote like members, wherein:

FIG. 1 is a view conceptually illustrating a finger vein and knuckle fingerprint image acquisition mechanism of an authentication device according to an exemplary embodiment of the known art;

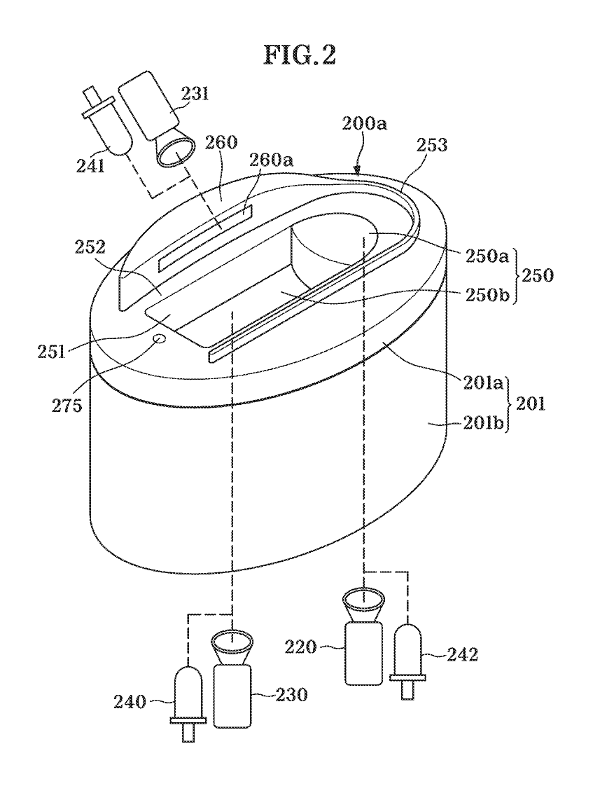

FIG. 2 is a view conceptually illustrating a finger vein and fingerprint image acquisition mechanism of an authentication device according to an exemplary embodiment of the present invention, shown is a first embodiment of a mounting portion at an upper portion on which a finger is placed;

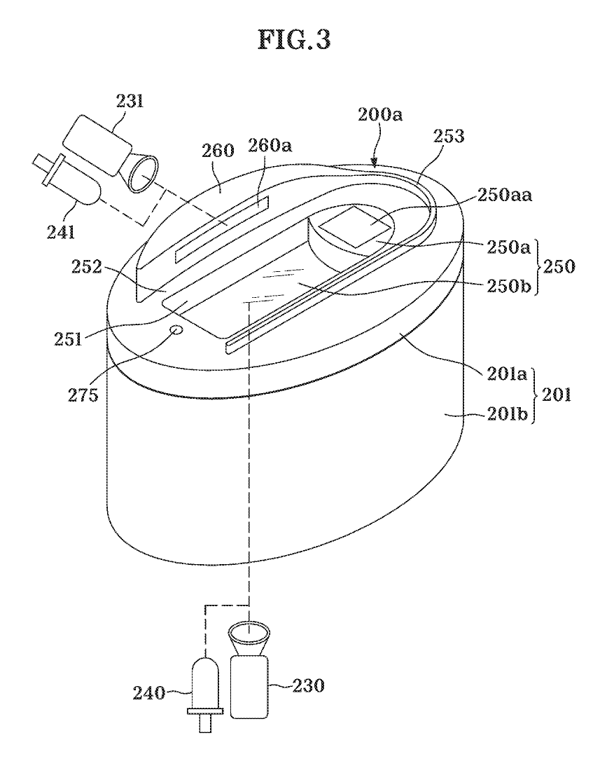

FIG. 3 is a view conceptually illustrating a finger vein and fingerprint image acquisition mechanism of an authentication device according to an exemplary embodiment of the present invention, shown is a second embodiment of a mounting portion at an upper portion on which a finger is placed;

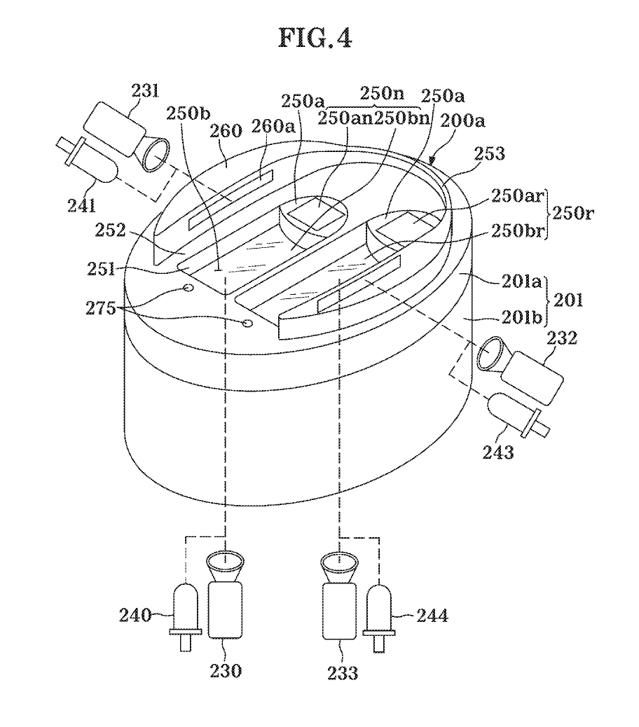

FIG. 4 is a view conceptually illustrating a mechanism of acquiring fingerprint and finger vein images of two fingers of an authentication device according to an exemplary embodiment of the present invention;

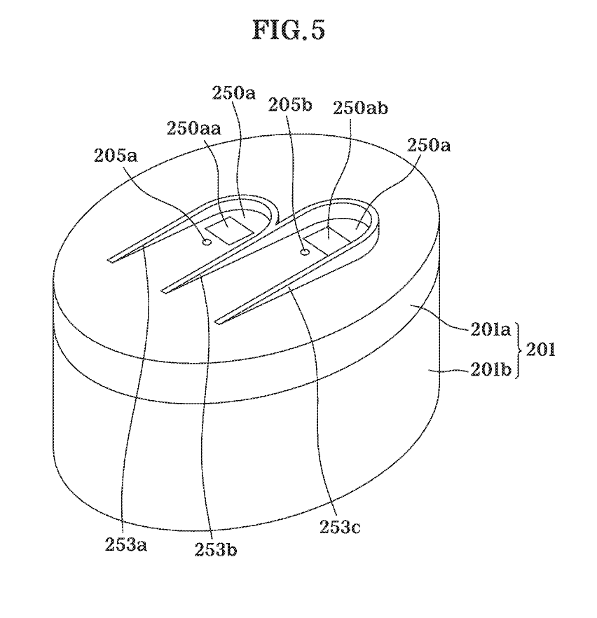

FIG. 5 is a view conceptually illustrating a mechanism of acquiring fingerprint images of two fingers of an authentication device according to an exemplary embodiment of the present invention;

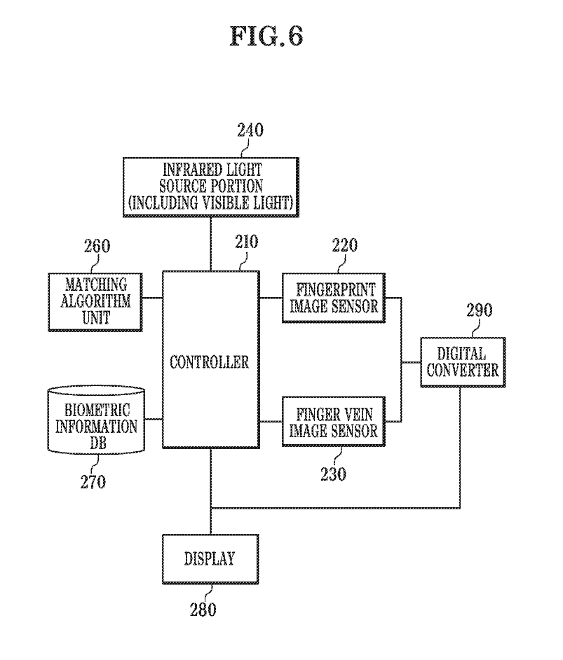

FIG. 6 is a view illustrating an internal electronic configuration example of an authentication device of the embodiments of present invention;

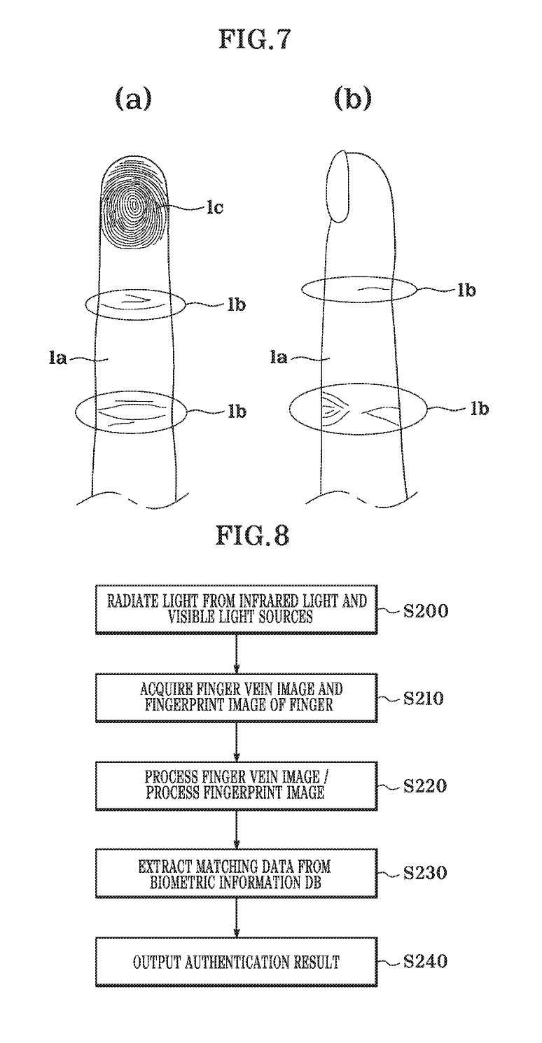

FIG. 7 illustrates a fingerprint surface (a) and a side (b) of the same finger whose images are captured by a finger vein image sensor and a fingerprint image sensor;

FIG. 8 is a view illustrating a configuration example of an entire process of an authentication method using an authentication device of embodiments of the present invention;

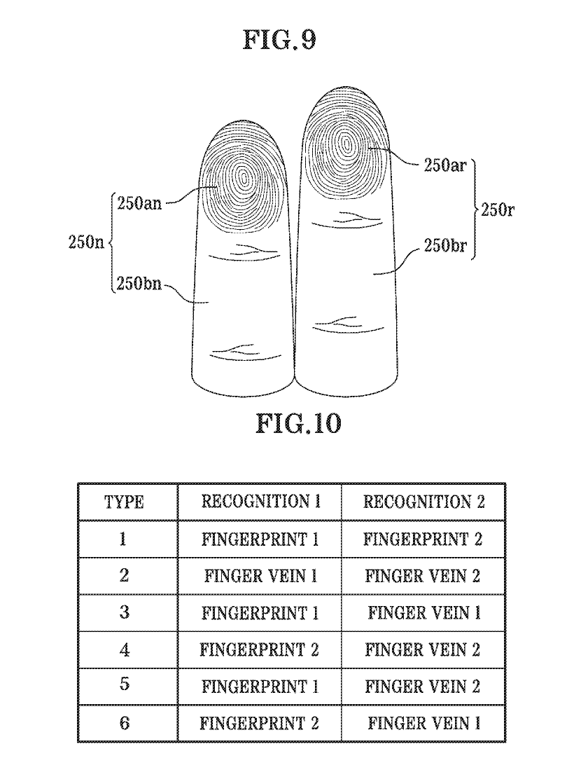

FIG. 9 is a view in which fingerprint and finger vein images of two fingers of embodiments of the present invention are illustrated by being distinguished from each other;

FIG. 10 is a matrix table showing possible combination pairs of Fingerprint 1, Fingerprint 2, Finger vein 1, and Finger vein 2 of embodiments of the present invention;

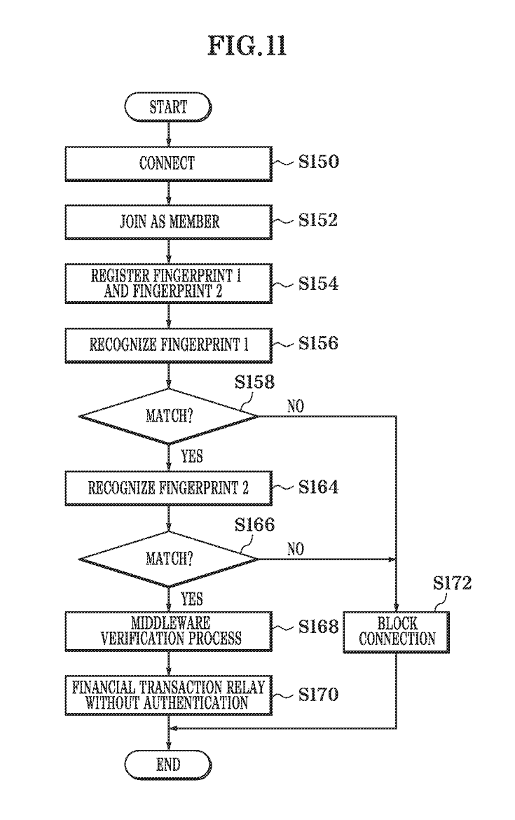

FIG. 11 is a flowchart of a case in which Fingerprint 1 and Fingerprint 2 of embodiments of the present invention are authenticated simultaneously;

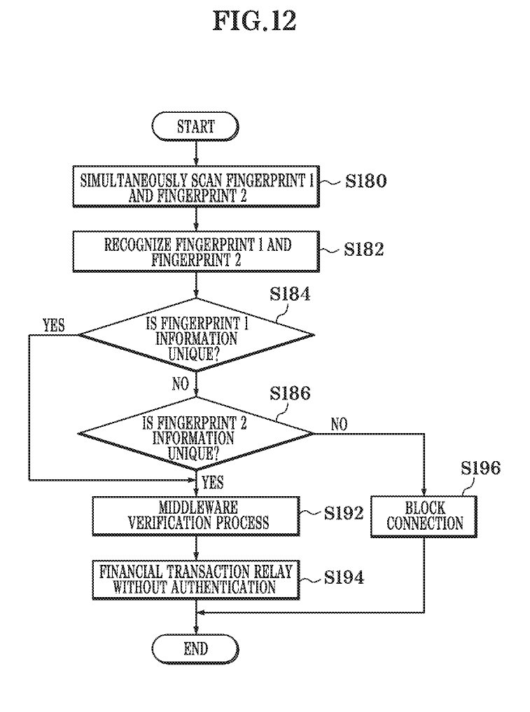

FIG. 12 is a flowchart of a case in which Fingerprint 1 and Fingerprint 2 of embodiments of the present invention are authenticated simultaneously;

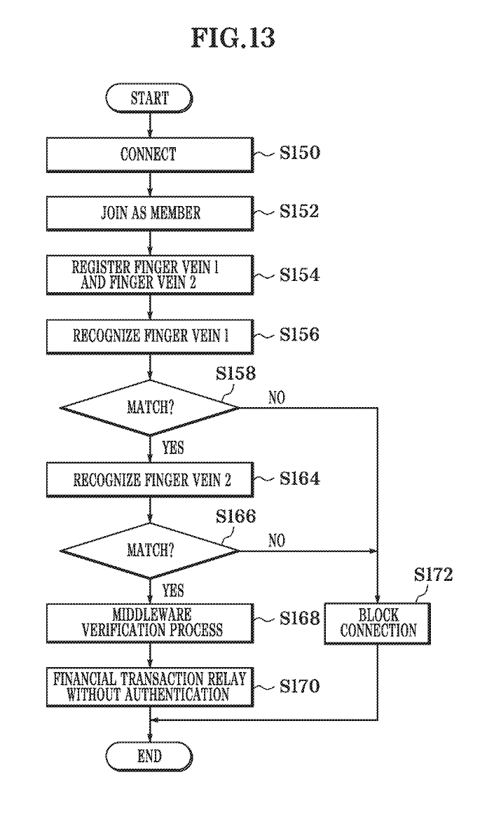

FIG. 13 is a flowchart of a case in which Finger vein 1 and Finger vein 2 of embodiments of the present invention are authenticated simultaneously;

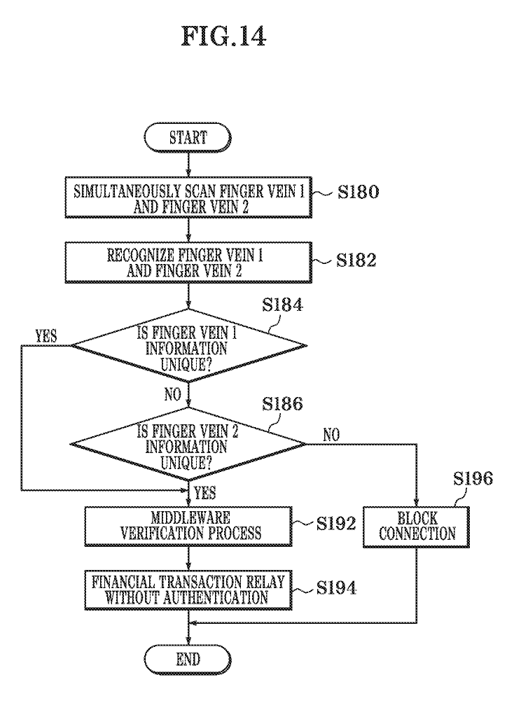

FIG. 14 is a flowchart of a case in which Finger vein 1 and Finger vein 2 of embodiments of the present invention are authenticated simultaneously;

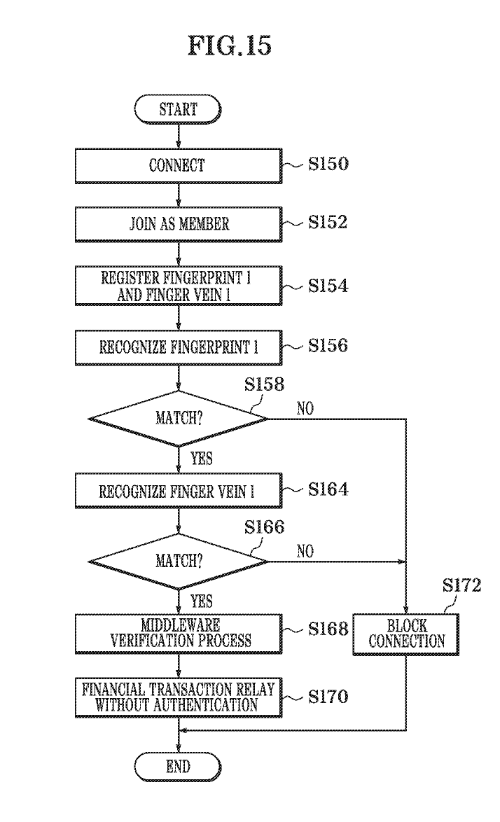

FIG. 15 is a flowchart of a case in which Fingerprint 1 and Finger vein 1 of embodiments of the present invention are authenticated simultaneously;

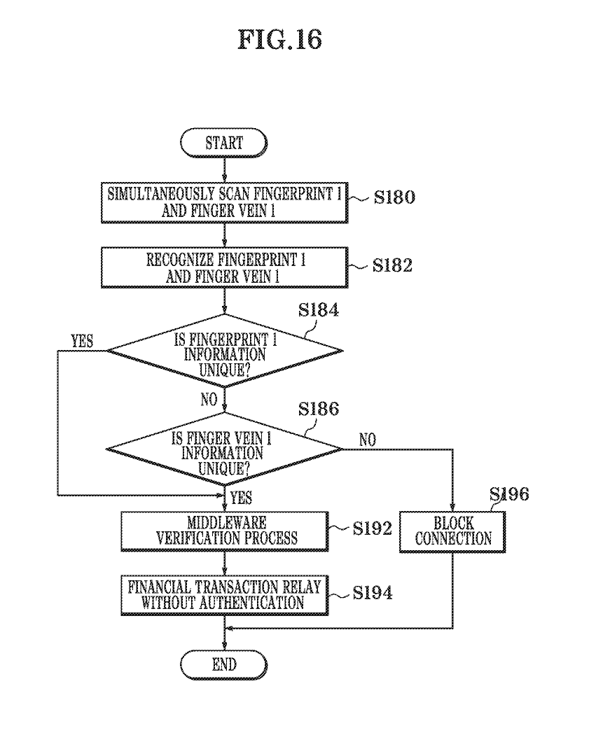

FIG. 16 is a flowchart of a case in which Fingerprint 1 and Finger vein 1 of embodiments of the present invention are authenticated simultaneously;

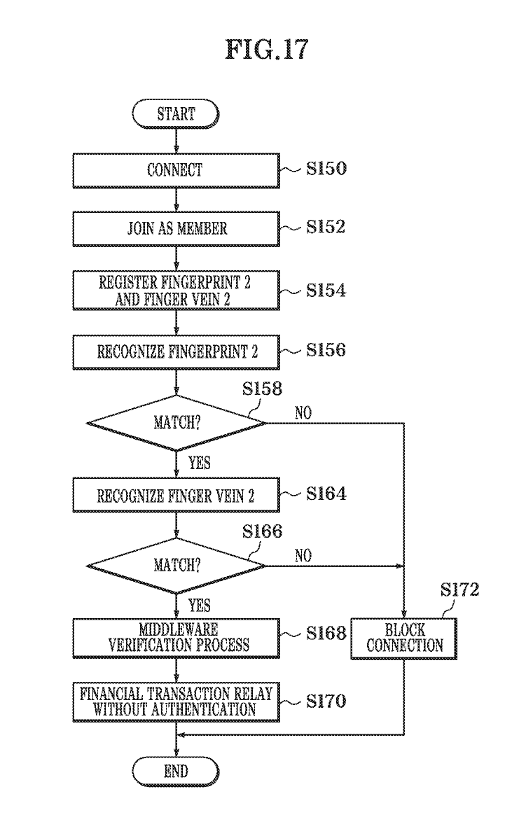

FIG. 17 is a flowchart of a case in which Fingerprint 2 and Finger vein 2 of embodiments of the present invention are authenticated simultaneously;

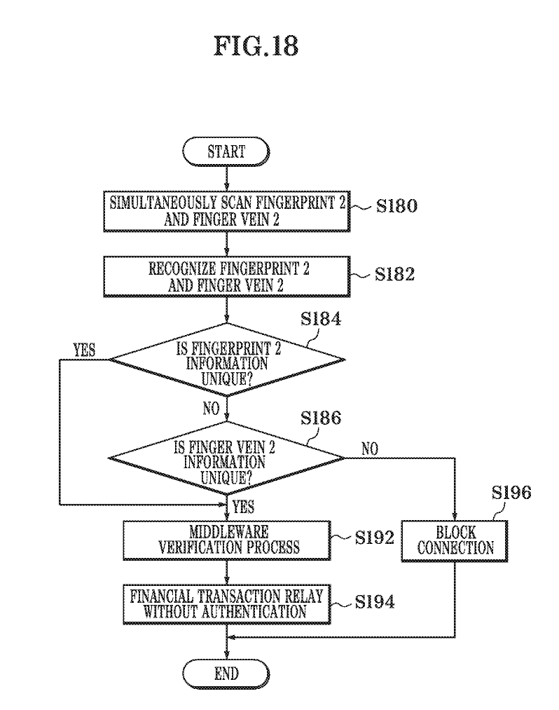

FIG. 18 is a flowchart of a case in which Fingerprint 2 and Finger vein 2 of embodiments of the present invention are authenticated simultaneously;

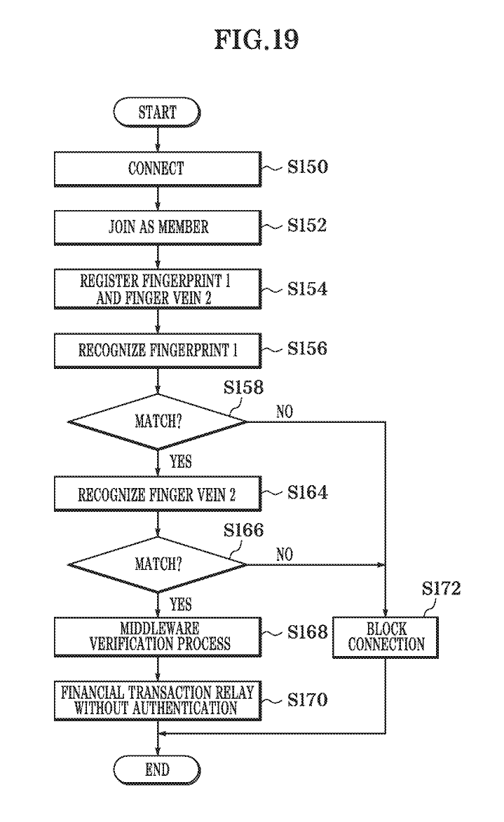

FIG. 19 is a flowchart of a case in which Fingerprint 1 and Finger vein 2 of embodiments of the present invention are authenticated simultaneously;

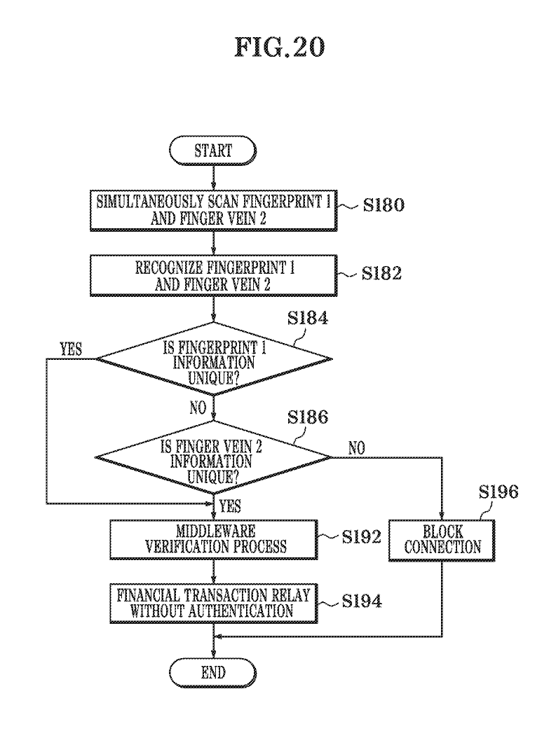

FIG. 20 is a flowchart of a case in which Fingerprint 1 and Finger vein 2 of embodiments of the present invention are authenticated simultaneously;

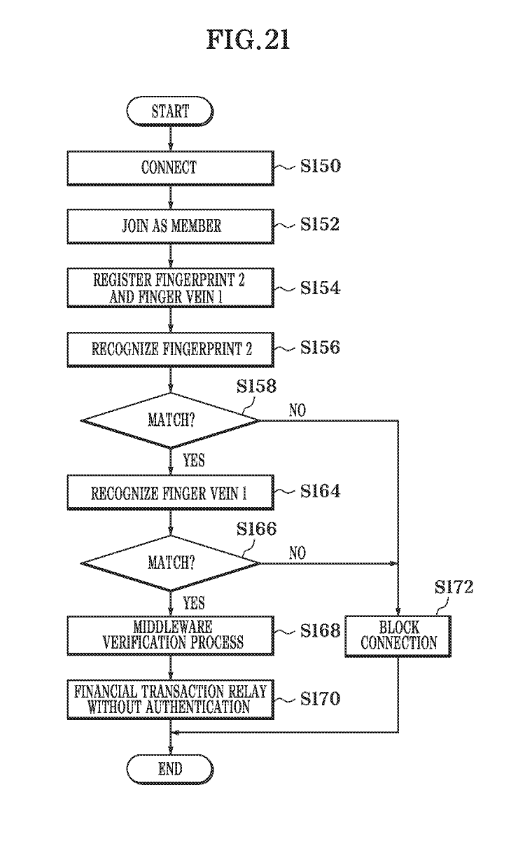

FIG. 21 is a flowchart of a case in which Fingerprint 2 and Finger vein 1 of embodiments of the present invention are authenticated simultaneously;

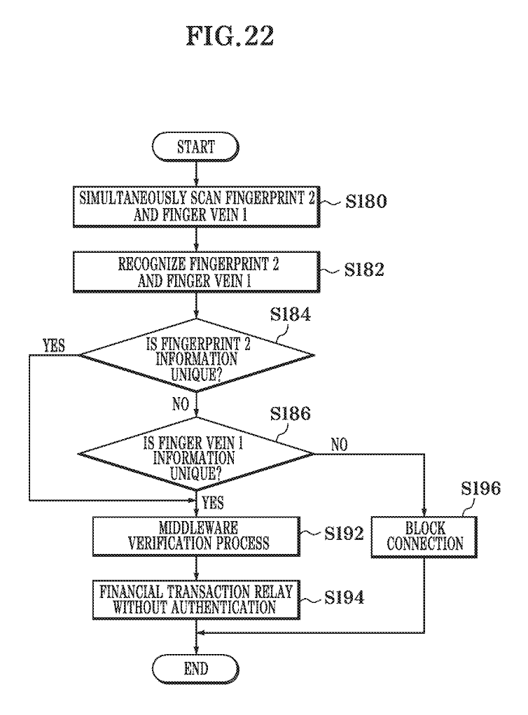

FIG. 22 is a flowchart of a case in which Fingerprint 2 and Finger vein 1 of embodiments of the present invention are authenticated simultaneously;

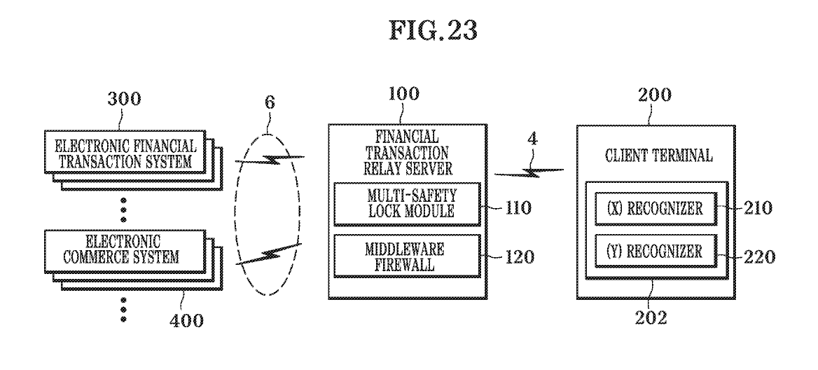

FIG. 23 is a block diagram illustrating a financial transaction system of embodiments of the present invention.

### BRIEF DESCRIPTION OF REFERENCE NUMERALS

200: integrated imaging and authentication device
201: object accommodating portion
201a: scan panel upper case
201b: scan panel lower case
22, 230, 231: image sensor
240, 241: infrared light source portion
242: visible light source portion
250: scan panel
250a: fingerprint finger contact portion
250b: finger vein finger non-contact portion
260a: infrared light side transmitter
260: infrared light side transmitter case

### DETAILED DESCRIPTION

In describing embodiments of the present invention, when detailed description of a related known function that is self-evident to those of ordinary skill in the art is determined as having the possibility of unnecessarily blurring the gist of embodiments of the present invention, the detailed description thereof will be omitted.

FIG. 1 is a view conceptually illustrating a finger vein and knuckle fingerprint image acquisition mechanism of an authentication device 100 according to an exemplary embodiment of the known art. FIGS. 2 and 3 are views conceptually illustrating a finger vein and fingerprint image acquisition mechanism of an authentication device 100 according to an exemplary embodiment of embodiments of the present invention, each of which are different embodiments of a mounting portion at an upper portion on which a finger is placed. FIG. 4 is a view conceptually illustrating a mechanism of acquiring fingerprint and finger vein images of two fingers of an authentication device 200 according to an exemplary embodiment of the present invention. FIG. 5 is a view conceptually illustrating a mechanism of acquiring fingerprint images of two fingers of an authentication device 200 according to an exemplary embodiment of the present invention. FIG. 6 is a view illustrating an internal electronic configuration example of an authentication device 200 of embodiments of the present invention. FIG. 7 illustrates a fingerprint surface (a) and a side (b) of the same finger whose images are captured by a finger vein image sensor and a fingerprint image sensor. FIG. 8 is a view illustrating a configuration example of an entire process of an authentication method using an authentication device of embodiments of the present invention.

As seen in FIG. 2, embodiments of the present invention may be an integrated imaging and authentication device 200 capable of capturing images of fingerprints and finger veins. The integrated imaging and authentication device 200 includes: an object accommodating portion 201 including a scan panel upper case 201a, which forms a finger mounting portion, formed at an upper portion and including a scan panel lower case 201b, which accommodates a full-length portion of the scan panel upper case 201a, formed at a lower portion; and a scan panel 250, which is formed of a transparent material such as glass or acryl, provided at an upper portion of the scan panel upper case 201a and configured to simultaneously capture images of fingerprints and finger veins. In the scan panel 250, a fingerprint finger contact portion 250a and a finger vein finger non-contact portion 250b may be formed at a front portion and a rear portion, respectively, with a height difference.

A groove sidewall 251 is formed at an edge of the finger vein finger non-contact portion 250b of the scan panel 250 so that the finger vein finger non-contact portion 250b is formed as a groove, and a finger mounting portion 252 is formed in parallel with the fingerprint finger contact portion 250a so that a finger is allowed to be placed around an upper edge of the finger vein finger non-contact portion 250b.

In addition, a temperature sensor 275 configured to detect a bloodstream temperature of a finger is formed in front of the finger vein finger non-contact portion 250b opposite the fingerprint finger contact portion 250a of the scan panel 250. In this way, when a finger is brought into contact with the temperature sensor 275, a temperature and bloodstream of the finger may be detected, and finger veins may be recognized by the detected temperature and bloodstream.

In addition, in order to capture more accurate finger vein images, an infrared light side transmitter case 260 configured to accommodate an infrared light side transmitter 260a is longitudinally formed at one side so that images of finger veins may be captured from the side.

The scan panel lower case 201b is formed as a space in which electric components may be accommodated.

In addition, a finger mounting boundary 253, within which a finger may be mounted, is formed.

Therefore, in a first embodiment of the present invention, a user places a finger object on the scan panel 250 to start finger vein authentication, and upon start of finger vein authentication by the device, an infrared light source portion 240 and a visible light source portion 242 irradiate the finger object with infrared light and visible light.

Then, a plurality of visible light image sensors capture images of fingerprints and finger veins of the finger which have been irradiated with the infrared light and visible light.

In the first embodiment of the present invention, two image sensors 220 and 230 are embedded in the integrated imaging and authentication device 200. A finger vein image sensor 230 is provided by being embedded in the object accommodating portion 201 and captures an image of finger veins of the object toward the scan panel 205 from below the scan panel 205. In addition, almost simultaneously, a fingerprint image sensor 220, which is provided in the same object accommodating portion 201, captures an image of a fingerprint of the object.

As a second embodiment of the present invention, a user places a finger object on the scan panel 250 to start finger vein authentication, and upon start of finger vein authentication by the device, infrared light source portions 240 and 241 and a visible light source portion 242 irradiate the finger object with infrared light and visible light.

Then, image sensors thereof capture images of fingerprints and finger veins of the finger which have been irradiated with the infrared light and visible light.

In the second embodiment of the present invention, three image sensors 220, 230, and 231 are embedded in the integrated imaging and authentication device 200. Finger vein image sensors 230 and 231 are provided by being embedded in an object accommodating portion 201 and capture images of finger veins of the object toward the scan panel 250 from below and beside the scan panel 250. In addition, almost simultaneously, a fingerprint image sensor 220, which is provided in the same object accommodating portion 201, captures an image of a fingerprint of the object.

In a preferred exemplary embodiment of the present invention, the finger vein image sensors 230 and 231 and the fingerprint image sensor 220 simultaneously capture images of finger veins and fingerprints of the finger, and both images are used as biometric information. In this way, an error range may be reduced to, at maximum, one over a square of a certain value as compared to when a fingerprint image and a finger vein image are separately captured to measure a fingerprint or finger veins.

In a preferred embodiment of the present invention, the finger vein image sensors 230 and 231 and the fingerprint image sensor 220 may capture a finger vein image and a fingerprint image of a single finger at once. Here, the finger vein image is captured from a side that is 90° from a fingerprint surface so that a fingerprint image and a finger vein image are simultaneously obtained from a single finger, thereby obtaining the above-mentioned effect of reducing the error range. When capturing an image of a side of a finger, the finger is rotated toward the side that is 90° from the fingerprint surface while the finger is placed on the scan panel so that the side of the finger is in contact with the scan panel.

FIG. 3 is a third embodiment of the present invention. The third embodiment is mostly the same as the embodiment illustrated in FIG. 2. However, in a fingerprint recognizing portion, while the three image sensors 220, 230, and 231 are embedded in the integrated imaging and authentication device 200 in the second embodiment, a fingerprint recognition module 250aa is formed instead of the fingerprint image sensor 220 and a method capable of determining a fingerprint by contact with the fingerprint is provided in the third embodiment.

The fingerprint recognition module 250aa is formed as a multi-layer thin plate structure. A fingerprint recognition layer is formed at an upper layer portion of the fingerprint recognition module, and a temperature and bloodstream detection authentication layer is formed below the fingerprint recognition layer so that operation of the fingerprint recognition module 250aa may be started after a temperature and bloodstream of the human body are detected.

FIG. 4 is a fourth embodiment of the present invention in which two fingerprints and finger veins are used. The same reference numerals and technical terms will be used for technical configurations which are the same as those of the embodiment illustrated in FIG. 2.

As seen in FIG. 4, embodiments of the present invention is an integrated imaging and authentication device 200 capable of capturing images of fingerprints and finger veins. The integrated imaging and authentication device 200 includes: an object accommodating portion 201 including a scan panel upper case 201a, which forms a finger mounting portion, formed at an upper portion and including a scan panel lower case 201b, which accommodates a full-length portion of the scan panel upper case 201a, formed at a lower portion; and two scan panels 250n and 250r, which are formed of a transparent material such as glass or acryl, provided at an upper portion of the scan panel upper case 201a and configured to simultaneously capture images of fingerprints and finger veins of two fingers. In the two scan panels 250n and 250r, fingerprint finger contact portions 250an and 250ar and finger vein finger non-contact portions 250bn and 250br are formed at front portions and rear portions, respectively, with a height difference.

A groove sidewall 251 is formed at an edge of the finger vein finger non-contact portion 250bn of any one scan panel 250n so that the finger vein finger non-contact portion 250bn is formed as a groove, and a finger mounting portion 252 is formed in parallel with the fingerprint finger contact portion 250a so that a finger is allowed to be placed around an upper edge of the finger vein finger non-contact portion 250bn.

In addition, a temperature sensor 275 configured to detect a bloodstream or temperature of a finger is formed in front of the finger vein finger non-contact portion 250bn opposite the fingerprint finger contact portion 250an of the scan panel 250. In this way, when a finger is brought into contact with the temperature sensor 275, a temperature or bloodstream of the finger may be detected, and finger veins may be recognized by the detected temperature or bloodstream.

Further, temperature sensors 205a and 205b configured to detect a bloodstream or temperature of a finger may be formed at lower portions of fingerprint finger contact portions 250aa and 250ab of the scan panels, or a thin plate layer configured to authenticate a bloodstream or temperature of the finger may be formed at any one layer of fingerprint recognition modules 250aa and 250ab. In this way, operation of the fingerprint recognition modules 250aa and 250ab may not be allowed when the two fingers are not simultaneously authenticated.

That is, the fingerprint recognition modules 250an and 250ar may be formed instead of the temperature sensor 275. The fingerprint recognition modules 250an and 250ar may be formed as multi-layer thin plate structures. A fingerprint recognition layer is formed at upper layer portions of the fingerprint recognition modules and a temperature and bloodstream detection authentication layer is formed below the fingerprint recognition layer so that operation of the fingerprint recognition modules 250an and 250ar may be started after a temperature and bloodstream of the human body are detected.

In addition, in order to capture more accurate finger vein images, an infrared light side transmitter case 260 configured to accommodate an infrared light side transmitter 260a is longitudinally formed at one side so that images of finger veins may be captured from the side.

In addition, a user places finger objects on the scan panels 250n and 250r to start finger vein authentication, and upon start of finger vein authentication by the device, infrared light source portions 241 and 243 irradiate the finger objects with infrared light from the left side and the right side, respectively, and infrared light source portions 240 and 244 irradiate the finger objects with infrared light from the lower side.

Then, left and right image sensors 231 and 232 and lower image sensors 230 and 233 thereof capture finger vein images of the fingers that have been irradiated with the infrared light.

The scan panel lower case 201b is formed as a space in which electric components may be accommodated.

In addition, a finger mounting boundary 253, within which a finger may be mounted, is formed.

Therefore, in a fourth embodiment of the present invention, a user places finger objects on the scan panels 250n and 250r to start fingerprint and finger vein authentication, and upon start of fingerprint and finger vein authentication by the device, the infrared light source portions 240 and 244 irradiate the finger objects with infrared light.

To ensure accuracy, the finger objects are irradiated with infrared light by the infrared light source portions 241 and 243 formed at the left and right sides, respectively.

In addition, almost simultaneously, the fingerprint authentication modules 250an and 250ar, which are provided in the same object accommodating portion 201, authenticate fingerprints of the objects.

In a preferred exemplary embodiment of the present invention, images of finger veins and fingerprints of the fingers are simultaneously captured, and both images are used as biometric information. In this way, an error range may be reduced to, at maximum, one over a square of a certain value as compared to when a fingerprint image and a finger vein image are separately captured to measure a fingerprint or finger veins.

FIG. 5 is a fifth embodiment of the present invention in which fingerprints of two fingers are used. The same reference numerals and technical terms will be used for technical configurations which are the same as those of the embodiments illustrated in FIGS. 2 and 4.

As seen in FIG. 5, the fifth embodiment is mostly the same as the embodiments illustrated in FIGS. 2 and 4. However, in the fifth embodiment, fingerprint recognition modules 250aa and 250ab are formed instead of the fingerprint image sensor 220 in the other embodiments so that two fingerprints may be simultaneously authenticated only using a fingerprint recognition portion, and a method capable of determining fingerprints by contact with the fingerprints is provided.

Even in this case, to increase security rate, the above-described temperature sensors 205a and 205b configured to detect a bloodstream temperature of fingers may be formed in front of the fingerprint recognition modules 250aa and 250ab. In this way, when fingers are brought into contact with the temperature sensors 205a and 205b, temperatures and bloodstreams of the fingers may be detected, and finger veins may be recognized by the detected temperatures and bloodstreams.

The fingerprint recognition modules 250aa and 250ab may be formed instead of the temperature sensors 205a and 205b. The fingerprint recognition modules 250aa and 250ab may be formed as multi-layer thin plate structures. A fingerprint recognition layer is formed at upper layer portions of the fingerprint recognition modules and a temperature and bloodstream detection authentication layer is formed below the fingerprint recognition layer so that operation of the fingerprint recognition modules 250aa and 250ab may be started after a temperature and bloodstream of the human body are detected.

FIG. 6 is an internal electronic configuration example of a finger vein imaging and authentication device 200 according to a preferred exemplary embodiment of the present invention.

An integrated imaging and authentication device 200 includes an infrared light source portion 240, a finger vein image sensor 230, a fingerprint image sensor 220, a digital converter 290, a decoding algorithm unit 260, a biometric information data storage 270, and a display 280.

Although not illustrated, the integrated imaging and authentication device 200 may further include a power supply unit, a communication unit, and various input/output (I/O) devices.

The infrared light source portion 240 radiates infrared light toward an object accommodating portion. Preferably, the infrared light source portion 240 may include one or more light emitting diodes (LEDs) and emit infrared light having a wavelength of 630 to 1,000 nm that is suitable for capturing a finger vein image. In addition, preferably, an optical filter may be provided in the infrared light source portion 240 to eliminate optical noise.

A visible light source portion 242 radiates visible light toward the object accommodating portion. The visible light source portion 242 may include one or more LEDs and emit ultraviolet light having a wavelength suitable for capturing an image of fingerprints on a surface of a finger.

In addition, in an exemplary embodiment of the present invention, a single infrared light source portion 240 configured to radiate infrared light toward an object accommodating portion and a single visible light source portion 242 configured to radiate visible light toward the object accommodating portion may be provided.

In another embodiment of the present invention, a plurality of infrared light source portions 240 and a plurality of visible light source portions 242 may be provided in an object accommodating portion 101 so that infrared light and visible light evenly reach an object, thereby optimizing image acquisition.

In a preferred embodiment of the present invention, finger vein image sensors 230 and 231 acquire a finger vein image of a single finger object from below and beside the finger object.

In another preferred embodiment of the present invention, a finger vein image sensor 230 acquires a fingerprint image and a side finger vein image of a single finger object.

(a) and (b) of FIG. 7 show angles at which infrared imaging is performed on an inner surface and a side of a single finger.

The reference numeral 1a, which has not been described above, indicates a finger vein portion between knuckles, the reference numeral 1b refers to a knuckle, and the reference numeral 1c refers to a fingerprint portion.

When capturing a front image of a finger object, the image is captured while the finger is placed such that a fingerprint surface of the finger comes into contact with a scan panel, and according to the number of finger vein image sensors 230, 231, 232, and 233, the finger is rotated sideways by 90° so that a side of the finger is in contact with the scan panel. An order of imaging the fingerprint surface and the side of the finger may be reversed.

The digital converter 290 receives both the finger vein image and the fingerprint image and extracts the images as finger vein and fingerprint images. The following obtains finger vein and fingerprint image files of a finger by using the digital converter 290.

A controller 210 allows the image files converted in the digital converter 290 to be sent to the matching algorithm unit 260.

Previously-stored biometric information of a user is stored in the biometric information data storage 270. In an exemplary embodiment of the present invention, the biometric information data storage 270 may be constructed in an internal memory of the authentication device 200.

In another embodiment of the present invention, the data storage 270 may be disposed in a storage outside the device and may be accessed via wired or wireless communication.

A crypto-processor, which may be protected from hardware and software attacks from the outside or theft, may be used as the biometric information data storage 270.

The matching algorithm unit 260 acquires user data stored in the biometric information data storage 270 and then determines whether the acquired user data matches a user biometric information value acquired by the digital converter 290. When the user data matches the user biometric information value, a success message may be output on the display 280. When decoding has failed, an authentication failure message may be output on the display 280.

The controller 210 controls operations and functions of the authentication device 200.

Particularly, the controller 210 controls finger vein image acquisition, processing, authentication computation, and determines an authentication result. Various pieces of software may be used in relation to processing and computation of an acquired finger vein image.

For example, a Canny edge detector algorithm may be used. A Gaussian filter may be applied to eliminate noise from an original image as a whole. The image is formed into an image that consists of edges by using image gradient. That is, sketch lines of the image are extracted. A task of decreasing thicknesses of the edges (sketch lines) is performed by applying non-maximum suppression, and bold edges are classified as definite edges while faded edges are assumed to be noise and classified as weak edges by applying a double threshold. Then, lastly, the weak edges are deleted and only the definite edges are kept in order to ultimately output a finger vein image which consists of edges.

An embodiment of an authentication process of an authentication device of embodiments the present invention will be re-summarized on the basis of the above detailed description. The process is shown in FIG. 8.

First, an authentication target places his or her finger on an object accommodating portion of an authentication device which is in a standby state. Here, an authentication method is a method in which images of a fingerprint surface and finger veins of a single finger are captured from below and/or beside the finger.

In the case of the embodiment in which authentication is performed using only one finger, infrared and visible light imaging of a fingerprint surface and a side of a single finger (S200) and imaging of finger veins and fingerprints (S210) are repeated a total of two to three times.

That is, after S200 and S210 are performed on a fingerprint surface of a single finger, S200 and S210 are performed on a side of the same finger. The finger vein and fingerprint images which have been captured in this way are converted into digital images.

Next, a controller extracts the captured fingerprint and finger vein images (S220). Here, as shown in (a) and (b) of FIG. 7, a fingerprint extracted from a fingerprint image and a portion between two knuckle wrinkles may be used as image extraction regions, and the image extraction regions may be processed into a finger vein image, which consists of edges, using the above-described Canny edge detector algorithm.

Then, the user's biometric data stored in a biometric information data storage is compared with fingerprint and finger vein images of a finger that have “just” been acquired and processed. When the biometric data and the images match each other, it is determined as a success of fingerprint and finger vein authentication, and when the biometric data and the images fail to match each other, it is determined as an authentication failure.

An authentication result is displayed on a display. The result may also be displayed with a sound.

Next, a method of capturing images of two fingers will be described.

First, an authentication target places his or her finger on an object accommodating portion of an authentication device which is in a standby state. Here, an authentication method is a method in which images of fingerprint surfaces and finger veins of two fingers are captured from below and/or beside the fingers.

In the case of the embodiment in which authentication is performed using two fingers, infrared imaging of a fingerprint surface and a lower portion or side of two fingers (S200) and imaging of finger veins and fingerprints (S210) are repeated a total of two to three times.

That is, after S200 and S210 are performed on fingerprint surfaces of two fingers, S200 and S210 are performed on a side of the same finger. The finger vein and fingerprint images which have been captured in this way are converted into digital images.

Here, any one of the lower portion and the side may be omitted depending on the design.

Next, a controller extracts the captured fingerprint and finger vein images (S220). Here, as shown in (a) and (b) of FIG. 7, a fingerprint extracted from a fingerprint image and a portion between two knuckle wrinkles may be used as image extraction regions, and the image extraction regions may be processed into a finger vein image, which consists of edges, using the above-described Canny edge detector algorithm.

Then, the user's biometric data stored in a biometric information data storage is compared with fingerprint and finger vein images of fingers that have “just” been acquired and processed. When the biometric data and the images match each other, it is determined as a success of fingerprint and finger vein authentication, and when the biometric data and the images fail to match each other, it is determined as an authentication failure.

An authentication result is displayed on a display. The authentication result may also be displayed with a sound.

An authentication device of embodiments of the present invention performs authentication by simultaneously utilizing, for example, fingerprint images and finger vein data of fingers, thereby significantly reducing a false acceptance rate.

Next, a method of utilizing images of recognized fingerprints and finger veins will be described.

FIG. 9 is a view in which fingerprint and finger vein images of two fingers of embodiments of the present invention are illustrated by being distinguished from each other, and FIG. 10 is a matrix table showing possible combination pairs of Fingerprint 1, Fingerprint 2, Finger vein 1, and Finger vein 2 of embodiments of the present invention.

Here, there are six cases in which the number of fingerprint and finger vein images may be at least more than one.

That is, the six cases include: 1) Fingerprint 1 (250an) and Fingerprint 2 (250ar); 2) Finger vein 1 (250bn) and Finger vein 2 (250br); 3) Fingerprint 1 (250an) and Finger vein 1 (250bn); 4) Fingerprint 2 (250ar) and Finger vein 2 (250br); 5) Fingerprint 1 (250an) and Finger vein 2 (250br); and 6) Fingerprint 2 (250ar) and Finger vein 1 (250bn). Although the fingerprints and finger veins may be combined in other more complicated forms, it is possible to cover the whole population of the world just with combination pairs.

Next, a method will be described in which whether a user is authenticated is determined from a fingerprint and finger vein combination and a financial transaction is relayed without authentication through middleware verification.

FIGS. 11 and 12 are flowcharts of a case in which Fingerprint 1 and Fingerprint 2 of embodiments of the present invention are authenticated simultaneously. FIGS. 13 and 14 are flowcharts of a case in which Finger vein 1 and Finger vein 2 of embodiments of the present invention are authenticated simultaneously. FIGS. 15 and 16 are flowcharts of a case in which Fingerprint 1 and Finger vein 1 of embodiments of the present invention are authenticated simultaneously. FIGS. 17 and 18 are flowcharts of a case in which Fingerprint 2 and Finger vein 2 of embodiments of the present invention are authenticated simultaneously. FIGS. 19 and 20 are flowcharts of a case in which Fingerprint 1 and Finger vein 2 of embodiments of the present invention are authenticated simultaneously. FIGS. 21 and 22 are flowcharts of a case in which Fingerprint 2 and Finger vein 1 of embodiments of the present invention are authenticated simultaneously. FIG. 23 is a block diagram illustrating a financial transaction system of embodiments of the present invention.

FIG. 11 is a flowchart illustrating a different processing order of a financial transaction relay system having a multi-safety lock function using Fingerprint 1 authentication according to an embodiment of the present invention.

Referring to FIG. 11, in a financial transaction relay system 2 of embodiments of the present invention, a client terminal 200 connects to a financial transaction relay server 100 via a communication network 4 in step S150 and joins the server as a member in step S152. Here, the client terminal 200 inputs personal information of the client such as a name, an identification (ID), a password, a phone number, and an e-mail address.

In step S154, the client terminal 200 acquires Fingerprint 2 information and Fingerprint 1 information via a Fingerprint 2 recognizer 210 and a Fingerprint 1 recognizer 220, and when the Fingerprint 2 information and the Fingerprint 1 information are transmitted to the financial transaction relay server 100 via the communication network 4, the financial transaction relay server 100 registers the Fingerprint 2 information and the Fingerprint 1 information corresponding to the client terminal 200. Here, the financial transaction relay server 100 stores the Fingerprint 2 information and the Fingerprint 1 information in a database.

In step S156, to perform an electronic financial transaction and an electronic commerce transaction, the financial transaction relay server 100 firstly recognizes Fingerprint 1. In step S158, the financial transaction relay server 100 determines whether Fingerprint 1 matches the Fingerprint 1 information stored in the database and authenticates a user of the client terminal 200.

As a result of the determination, when the two pieces of information match, the financial transaction relay server 100 secondly recognizes Fingerprint 2 in step S164 and determines whether Fingerprint 2 matches the Fingerprint 2 information stored in the database in step S166.

As a result of the determination, when the two pieces of Fingerprint 2 information match, the process proceeds to step S168 and, thirdly, firewall protection is turned off in a multi-safety lock module 110 through a middleware verification processing unit 120 so that the database of the financial transaction relay server 100 may be opened. Then, in step S170, the financial transaction relay server 100 connects to an electronic financial transaction system 300 or an electronic commerce system 400 without authentication and processes a financial transaction to be relayed.

However, when either one of Fingerprint 2 information and Fingerprint 1 information from the client terminal 200 does not match in step S158 or step S166, the process proceeds to step S172, and connection of the financial transaction relay server 100 is blocked so that the financial transaction relay server 100 is not allowed to process an electronic financial transaction and an electronic commerce transaction.

This is because, in the case of Fingerprint 1 recognition, since Fingerprint 1 recognition is possible only when one is alive and thus is only possible by oneself, the security effect is unchanged even without another additional password process.

FIG. 12 is a flowchart illustrating a different processing order of a financial transaction relay system having a multi-safety lock function in which user authentication is processed by simultaneously scanning Fingerprint 1 and Fingerprint 2 according to another embodiment of the present invention. This embodiment is performed when user identification is difficult due to Fingerprint 1 information and Fingerprint 2 information being identical or similar to other fingerprint information. First user authentication is processed using Fingerprint 1 information, and when user identification in the first user authentication is difficult, Fingerprint 2 information is used secondarily to process user authentication.

That is, referring to FIG. 12, in a financial transaction relay system 2 of embodiments of the present invention, in step S180, Fingerprint 1 and Fingerprint 2 are simultaneously scanned by a Fingerprint 2 recognizer 210 and a Fingerprint 1 recognizer 220 of a client terminal 200, and the Fingerprint 2 information and the Fingerprint 1 information are provided to a financial transaction relay server 100.

In step S182, the financial transaction relay server 100 recognizes the Fingerprint 1 information and the Fingerprint 2 information. In step S184, the financial transaction relay server 100 compares the Fingerprint 1 information with other pieces of Fingerprint 1 information stored in a database and determines whether the Fingerprint 1 information is unique.

As a result of the determination, when the Fingerprint 1 information is unique, the process proceeds to step S188. When the Fingerprint 1 information is not unique, that is, when user identification is difficult due to the Fingerprint 1 information being identical or similar to other fingerprint information, the financial transaction relay server 100 compares the Fingerprint 2 information with other pieces of Fingerprint 2 information stored in a database and determines whether the Fingerprint 2 information is unique in step S186.

As a result of the determination, when the Fingerprint 2 information is unique, the process proceeds to step S188, and the financial transaction relay server 100 processes user authentication for disabling and enabling firewall protection.

In step S192, firewall protection is turned off in a multi-safety lock module 110 through a middleware verification processing unit 120 so that the database of the financial transaction relay server 100 may be opened. Then, in step S194, the financial transaction relay server 100 connects to an electronic financial transaction system 300 or an electronic commerce system 400 without authentication and processes a financial transaction to be relayed.

However, when user authentication is not possible using either one of Fingerprint 1 information and Fingerprint 2 information by the client terminal 200 in step S186 or step S190, the process proceeds to step S196, and connection of the financial transaction relay server 100 is blocked so that the financial transaction relay server 100 is not allowed to process an electronic financial transaction and an electronic commerce transaction.

FIG. 13 is a flowchart illustrating a different processing order of a financial transaction relay system having a multi-safety lock function using Finger vein 1 authentication according to an embodiment of the present invention.

Referring to FIG. 13, in a financial transaction relay system 2 of embodiments of the present invention, a client terminal 200 connects to a financial transaction relay server 100 via a communication network 4 in step S150 and joins the server as a member in step S152. Here, the client terminal 200 inputs personal information of the client such as a name, an ID, a password, a phone number, and an e-mail address.

In step S154, the client terminal 200 acquires Finger vein 2 information and Finger vein 1 information via a Finger vein 2 recognizer 210 and a Finger vein 1 recognizer 220, and when the Finger vein 2 information and the Finger vein 1 information are transmitted to the financial transaction relay server 100 via the communication network 4, the financial transaction relay server 100 registers the Finger vein 2 information and the Finger vein 1 information corresponding to the client terminal 200. Here, the financial transaction relay server 100 stores the Finger vein 2 information and the Finger vein 1 information in a database.

In step S156, to perform an electronic financial transaction and an electronic commerce transaction, the financial transaction relay server 100 firstly recognizes Finger vein 1. In step S158, the financial transaction relay server 100 determines whether Finger vein 1 matches the Finger vein 1 information stored in the database and authenticates a user of the client terminal 200.

As a result of the determination, when the two pieces of information match, the financial transaction relay server 100 secondly recognizes Finger vein 2 in step S164 and determines whether Finger vein 2 matches the Finger vein 2 information stored in the database in step S166.

As a result of the determination, when the two pieces of Finger vein 2 information match, the process proceeds to step S168 and, thirdly, firewall protection is turned off in a multi-safety lock module 110 through a middleware verification processing unit 120 so that the database of the financial transaction relay server 100 may be opened. Then, in step S170, the financial transaction relay server 100 connects to an electronic financial transaction system 300 or an electronic commerce system 400 without authentication and processes a financial transaction to be relayed.

However, when either one of Finger vein 2 information and Finger vein 1 information from the client terminal 200 does not match in step S158 or step S166, the process proceeds to step S172, and connection of the financial transaction relay server 100 is blocked so that the financial transaction relay server 100 is not allowed to process an electronic financial transaction and an electronic commerce transaction.

This is because, in the case of Finger vein 1 recognition, since Finger vein 1 recognition is possible only when one is alive and thus is only possible by oneself, the security effect is unchanged even without another additional password process.

FIG. 14 is a flowchart illustrating a different processing order of a financial transaction relay system having a multi-safety lock function in which user authentication is processed by simultaneously scanning Finger vein 1 and Finger vein 2 according to another embodiment of the present invention. This embodiment is performed when user identification is difficult due to Finger vein 1 information and Finger vein 2 information being identical or similar to other finger vein information. First user authentication is processed using Finger vein 1 information, and when user identification in the first user authentication is difficult, Finger vein 2 information is used secondarily to process user authentication.

That is, referring to FIG. 14, in a financial transaction relay system 2 of embodiments of the present invention, in step S180, Finger vein 1 and Finger vein 2 are simultaneously scanned by a Finger vein 2 recognizer 210 and a Finger vein 1 recognizer 220 of a client terminal 200, and the Finger vein 2 information and the Finger vein 1 information are provided to a financial transaction relay server 100.

In step S182, the financial transaction relay server 100 recognizes the Finger vein 1 information and the Finger vein 2 information. In step S184, the financial transaction relay server 100 compares the Finger vein 1 information with other pieces of Finger vein 1 information stored in a database and determines whether the Finger vein 1 information is unique.

As a result of the determination, when the Finger vein 1 information is unique, the process proceeds to step S188. When the Finger vein 1 information is not unique, that is, when user identification is difficult due to the Finger vein 1 information being identical or similar to other finger vein information, the financial transaction relay server 100 compares the Finger vein 2 information with another piece of Finger vein 2 information stored in a database and determines whether the Finger vein 2 information is unique in step S186.

As a result of the determination, when the Finger vein 2 information is unique, the process proceeds to step S188, and the financial transaction relay server 100 processes user authentication for disabling and enabling firewall protection.

In step S192, firewall protection is turned off in a multi-safety lock module 110 through a middleware verification processing unit 120 so that the database of the financial transaction relay server 100 may be opened. Then, in step S194, the financial transaction relay server 100 connects to an electronic financial transaction system 300 or an electronic commerce system 400 without authentication and processes a financial transaction to be relayed.

However, when user authentication is not possible using either one of Finger vein 1 information and Finger vein 2 information by the client terminal 200 in step S186 or step S190, the process proceeds to step S196, and connection of the financial transaction relay server 100 is blocked so that the financial transaction relay server 100 is not allowed to process an electronic financial transaction and an electronic commerce transaction.

FIG. 15 is a flowchart illustrating a different processing order of a financial transaction relay system having a multi-safety lock function using Fingerprint 1 authentication according to an embodiment of the present invention.

Referring to FIG. 15, in a financial transaction relay system 2 of embodiments of the present invention, a client terminal 200 connects to a financial transaction relay server 100 via a communication network 4 in step S150 and joins the server as a member in step S152. Here, the client terminal 200 inputs personal information of the client such as a name, an ID, a password, a phone number, and an e-mail address.

In step S154, the client terminal 200 acquires Finger vein 1 information and Fingerprint 1 information via a Finger vein 1 recognizer 210 and a Fingerprint 1 recognizer 220, and when the Finger vein 1 information and the Fingerprint 1 information are transmitted to the financial transaction relay server 100 via the communication network 4, the financial transaction relay server 100 registers the Finger vein 1 information and the Fingerprint 1 information corresponding to the client terminal 200. Here, the financial transaction relay server 100 stores the Finger vein 1 information and the Fingerprint 1 information in a database.

In step S156, to perform an electronic financial transaction and an electronic commerce transaction, the financial transaction relay server 100 firstly recognizes Fingerprint 1. In step S158, the financial transaction relay server 100 determines whether Fingerprint 1 matches the Fingerprint 1 information stored in the database and authenticates a user of the client terminal 200.

As a result of the determination, when the two pieces of information match, the financial transaction relay server 100 secondly recognizes Finger vein 1 in step S164 and determines whether Finger vein 1 matches the Finger vein 1 information stored in the database in step S166.

As a result of the determination, when the two pieces of Finger vein 1 information match, the process proceeds to step S168 and, thirdly, firewall protection is turned off in a multi-safety lock module 110 through a middleware verification processing unit 120 so that the database of the financial transaction relay server 100 may be opened. Then, in step S170, the financial transaction relay server 100 connects to an electronic financial transaction system 300 or an electronic commerce system 400 without authentication and processes a financial transaction to be relayed.

However, when either one of Finger vein 1 information and Fingerprint 1 information from the client terminal 200 does not match in step S158 or step S166, the process proceeds to step S172, and connection of the financial transaction relay server 100 is blocked so that the financial transaction relay server 100 is not allowed to process an electronic financial transaction and an electronic commerce transaction.

This is because, in the case of Fingerprint 1 recognition, since Fingerprint 1 recognition is possible only when one is alive and thus is only possible by oneself, the security effect is unchanged even without another additional password process.

FIG. 16 is a flowchart illustrating a different processing order of a financial transaction relay system having a multi-safety lock function in which user authentication is processed by simultaneously scanning Fingerprint 1 and Finger vein 1 according to another embodiment of the present invention. This embodiment is performed when user identification is difficult due to Fingerprint 1 information and Finger vein 1 information being identical or similar to other fingerprint information or finger vein information. First user authentication is processed using Fingerprint 1 information, and when user identification in the first user authentication is difficult, Finger vein 1 information is used secondarily to process user authentication.

That is, referring to FIG. 16, in a financial transaction relay system 2 of embodiments of the present invention, in step S180, Finger vein 1 and Fingerprint 1 are simultaneously scanned by a Finger vein 1 recognizer 210 and a Fingerprint 1 recognizer 220 of a client terminal 200, and the Finger vein 1 information and the Fingerprint 1 information are provided to a financial transaction relay server 100.

In step S182, the financial transaction relay server 100 recognizes the Fingerprint 1 information and the Finger vein 1 information. In step S184, the financial transaction relay server 100 compares the Fingerprint 1 information with other pieces of Fingerprint 1 information stored in a database and determines whether the Fingerprint 1 information is unique.

As a result of the determination, when the Fingerprint 1 information is unique, the process proceeds to step S188. When the Fingerprint 1 information is not unique, that is, when user identification is difficult due to the Fingerprint 1 information being identical or similar to other fingerprint information, the financial transaction relay server 100 compares the Finger vein 1 information with another piece of Finger vein 1 information stored in a database and determines whether the Finger vein 1 information is unique in step S186.

As a result of the determination, when the Finger vein 1 information is unique, the process proceeds to step S188, and the financial transaction relay server 100 processes user authentication for disabling and enabling firewall protection.

In step S192, firewall protection is turned off in a multi-safety lock module 110 through a middleware verification processing unit 120 so that the database of the financial transaction relay server 100 may be opened. Then, in step S194, the financial transaction relay server 100 connects to an electronic financial transaction system 300 or an electronic commerce system 400 without authentication and processes a financial transaction to be relayed.

However, when user authentication is not possible using either one of Fingerprint 1 information and Finger vein 1 information by the client terminal 200 in step S186 or step S190, the process proceeds to step S196, and connection of the financial transaction relay server 100 is blocked so that the financial transaction relay server 100 is not allowed to process an electronic financial transaction and an electronic commerce transaction.

FIG. 17 is a flowchart illustrating a different processing order of a financial transaction relay system having a multi-safety lock function using Fingerprint 2 authentication according to an embodiment of the present invention.

Referring to FIG. 17, in a financial transaction relay system 2 of embodiments of the present invention, a client terminal 200 connects to a financial transaction relay server 100 via a communication network 4 in step S150 and joins the server as a member in step S152. Here, the client terminal 200 inputs personal information of the client such as a name, an ID, a password, a phone number, and an e-mail address.

In step S154, the client terminal 200 acquires Finger vein 2 information and Fingerprint 2 information via a Finger vein 2 recognizer 210 and a Fingerprint 2 recognizer 220, and when the Finger vein 2 information and the Fingerprint 2 information are transmitted to the financial transaction relay server 100 via the communication network 4, the financial transaction relay server 100 registers the Finger vein 2 information and the Fingerprint 2 information corresponding to the client terminal 200. Here, the financial transaction relay server 100 stores the Finger vein 2 information and the Fingerprint 2 information in a database.

In step S156, to perform an electronic financial transaction and an electronic commerce transaction, the financial transaction relay server 100 firstly recognizes Fingerprint 2. In step S158, the financial transaction relay server 100 determines whether Fingerprint 2 matches the Fingerprint 2 information stored in the database and authenticates a user of the client terminal 200.

As a result of the determination, when the two pieces of information match, the financial transaction relay server 100 secondly recognizes Finger vein 2 in step S164 and determines whether Finger vein 2 matches the Finger vein 2 information stored in the database in step S166.

As a result of the determination, when the two pieces of Finger vein 2 information match, the process proceeds to step S168 and, thirdly, firewall protection is turned off in a multi-safety lock module 110 through a middleware verification processing unit 120 so that the database of the financial transaction relay server 100 may be opened. Then, in step S170, the financial transaction relay server 100 connects to an electronic financial transaction system 300 or an electronic commerce system 400 without authentication and processes a financial transaction to be relayed.

However, when either one of Finger vein 2 information and Fingerprint 2 information from the client terminal 200 does not match in step S158 or step S166, the process proceeds to step S172, and connection of the financial transaction relay server 100 is blocked so that the financial transaction relay server 100 is not allowed to process an electronic financial transaction and an electronic commerce transaction.

This is because, in the case of Fingerprint 2 recognition, since Fingerprint 2 recognition is possible only when one is alive and thus is only possible by oneself, the security effect is unchanged even without another additional password process.

FIG. 18 is a flowchart illustrating a different processing order of a financial transaction relay system having a multi-safety lock function in which user authentication is processed by simultaneously scanning Fingerprint 2 and Finger vein 2 according to another embodiment of the present invention. This embodiment is performed when user identification is difficult due to Fingerprint 2 information and Finger vein 2 information being identical or similar to other fingerprint information or finger vein information. First user authentication is processed using Fingerprint 2 information, and when user identification in the first user authentication is difficult, Finger vein 2 information is used secondarily to process user authentication.

That is, referring to FIG. 18, in a financial transaction relay system 2 of embodiments of the present invention, in step S180, Finger vein 2 and Fingerprint 2 are simultaneously scanned by a Finger vein 2 recognizer 210 and a Fingerprint 2 recognizer 220 of a client terminal 200, and the Finger vein 2 information and the Fingerprint 2 information are provided to a financial transaction relay server 100.

In step S182, the financial transaction relay server 100 recognizes the Fingerprint 2 information and the Finger vein 2 information. In step S184, the financial transaction relay server 100 compares the Fingerprint 2 information with other pieces of Fingerprint 2 information stored in a database and determines whether the Fingerprint 2 information is unique.

As a result of the determination, when the Fingerprint 2 information is unique, the process proceeds to step S188. When the Fingerprint 2 information is not unique, that is, when user identification is difficult due to the Fingerprint 2 information being identical or similar to other fingerprint information, the financial transaction relay server 100 compares the Finger vein 2 information with another piece of Finger vein 2 information stored in a database and determines whether the Finger vein 2 information is unique in step S186.

As a result of the determination, when the Finger vein 2 information is unique, the process proceeds to step S188, and the financial transaction relay server 100 processes user authentication for disabling and enabling firewall protection.

In step S192, firewall protection is turned off in a multi-safety lock module 110 through a middleware verification processing unit 120 so that the database of the financial transaction relay server 100 may be opened. Then, in step S194, the financial transaction relay server 100 connects to an electronic financial transaction system 300 or an electronic commerce system 400 without authentication and processes a financial transaction to be relayed.

However, when user authentication is not possible using either one of Fingerprint 2 information and Finger vein 2 information by the client terminal 200 in step S186 or step S190, the process proceeds to step S196, and connection of the financial transaction relay server 100 is blocked so that the financial transaction relay server 100 is not allowed to process an electronic financial transaction and an electronic commerce transaction.

FIG. 19 is a flowchart illustrating a different processing order of a financial transaction relay system having a multi-safety lock function using Fingerprint 1 authentication according to an embodiment of the present invention.

Referring to FIG. 19, in a financial transaction relay system 2 of embodiments of the present invention, a client terminal 200 connects to a financial transaction relay server 100 via a communication network 4 in step S150 and joins the server as a member in step S152. Here, the client terminal 200 inputs personal information of the client such as a name, an ID, a password, a phone number, and an e-mail address.

In step S154, the client terminal 200 acquires Finger vein 2 information and Fingerprint 1 information via a Finger vein 2 recognizer 210 and a Fingerprint 1 recognizer 220, and when the Finger vein 2 information and the Fingerprint 1 information are transmitted to the financial transaction relay server 100 via the communication network 4, the financial transaction relay server 100 registers the Finger vein 2 information and the Fingerprint 1 information corresponding to the client terminal 200. Here, the financial transaction relay server 100 stores the Finger vein 2 information and the Fingerprint 1 information in a database.

In step S156, to perform an electronic financial transaction and an electronic commerce transaction, the financial transaction relay server 100 firstly recognizes Fingerprint 1. In step S158, the financial transaction relay server 100 determines whether Fingerprint 1 matches the Fingerprint 1 information stored in the database and authenticates a user of the client terminal 200.

As a result of the determination, when the two pieces of information match, the financial transaction relay server 100 secondly recognizes Finger vein 2 in step S164 and determines whether Finger vein 2 matches the Finger vein 2 information stored in the database in step S166.

As a result of the determination, when the two pieces of Finger vein 2 information match, the process proceeds to step S168 and, thirdly, firewall protection is turned off in a multi-safety lock module 110 through a middleware verification processing unit 120 so that the database of the financial transaction relay server 100 may be opened. Then, in step S170, the financial transaction relay server 100 connects to an electronic financial transaction system 300 or an electronic commerce system 400 without authentication and processes a financial transaction to be relayed.

However, when either one of Finger vein 2 information and Fingerprint 1 information from the client terminal 200 does not match in step S158 or step S166, the process proceeds to step S172, and connection of the financial transaction relay server 100 is blocked so that the financial transaction relay server 100 is not allowed to process an electronic financial transaction and an electronic commerce transaction.

This is because, in the case of Fingerprint 1 recognition, since Fingerprint 1 recognition is possible only when one is alive and thus is only possible by oneself, the security effect is unchanged even without another additional password process.

FIG. 20 is a flowchart illustrating a different processing order of a financial transaction relay system having a multi-safety lock function in which user authentication is processed by simultaneously scanning Fingerprint 1 and Finger vein 2 according to another embodiment of the present invention. This embodiment is performed when user identification is difficult due to Fingerprint 1 information and Finger vein 2 information being identical or similar to other fingerprint information or finger vein information. First user authentication is processed using Fingerprint 1 information, and when user identification in the first user authentication is difficult, Finger vein 2 information is used secondarily to process user authentication.

That is, referring to FIG. 20, in a financial transaction relay system 2 of embodiments of the present invention, in step S180, Finger vein 2 and Fingerprint 1 are simultaneously scanned by a Finger vein 2 recognizer 210 and a Fingerprint 1 recognizer 220 of a client terminal 200, and the Finger vein 2 information and the Fingerprint 1 information are provided to a financial transaction relay server 100.

In step S182, the financial transaction relay server 100 recognizes the Fingerprint 1 information and the Finger vein 2 information. In step S184, the financial transaction relay server 100 compares the Fingerprint 1 information with other pieces of Fingerprint 1 information stored in a database and determines whether the Fingerprint 1 information is unique.

As a result of the determination, when the Fingerprint 1 information is unique, the process proceeds to step S188. When the Fingerprint 1 information is not unique, that is, when user identification is difficult due to the Fingerprint 1 information being identical or similar to other fingerprint information, the financial transaction relay server 100 compares the Finger vein 2 information with another piece of Finger vein 2 information stored in a database and determines whether the Finger vein 2 information is unique in step S186.

As a result of the determination, when the Finger vein 2 information is unique, the process proceeds to step S188, and the financial transaction relay server 100 processes user authentication for disabling and enabling firewall protection.

In step S192, firewall protection is turned off in a multi-safety lock module 110 through a middleware verification processing unit 120 so that the database of the financial transaction relay server 100 may be opened. Then, in step S194, the financial transaction relay server 100 connects to an electronic financial transaction system 300 or an electronic commerce system 400 without authentication and processes a financial transaction to be relayed.

However, when user authentication is not possible using either one of Fingerprint 1 information and Finger vein 2 information by the client terminal 200 in step S186 or step S190, the process proceeds to step S196, and connection of the financial transaction relay server 100 is blocked so that the financial transaction relay server 100 is not allowed to process an electronic financial transaction and an electronic commerce transaction.

FIG. 21 is a flowchart illustrating a different processing order of a financial transaction relay system having a multi-safety lock function using Fingerprint 2 authentication according to an embodiment of the present invention.

Referring to FIG. 21, in a financial transaction relay system 2 of embodiments of the present invention, a client terminal 200 connects to a financial transaction relay server 100 via a communication network 4 in step S150 and joins the server as a member in step S152. Here, the client terminal 200 inputs personal information of the client such as a name, an ID, a password, a phone number, and an e-mail address.

In step S154, the client terminal 200 acquires Finger vein 1 information and Fingerprint 2 information via a Finger vein 1 recognizer 210 and a Fingerprint 2 recognizer 220, and when the Finger vein 1 information and the Fingerprint 2 information are transmitted to the financial transaction relay server 100 via the communication network 4, the financial transaction relay server 100 registers the Finger vein 1 information and the Fingerprint 2 information corresponding to the client terminal 200. Here, the financial transaction relay server 100 stores the Finger vein 1 information and the Fingerprint 2 information in a database.

In step S156, to perform an electronic financial transaction and an electronic commerce transaction, the financial transaction relay server 100 firstly recognizes Fingerprint 2. In step S158, the financial transaction relay server 100 determines whether Fingerprint 2 matches the Fingerprint 2 information stored in the database and authenticates a user of the client terminal 200.

As a result of the determination, when the two pieces of Fingerprint 2 information match, the financial transaction relay server 100 secondly recognizes Finger vein 1 in step S164 and determines whether Finger vein 1 matches the Finger vein 1 information stored in the database in step S166.

As a result of the determination, when the two pieces of information match, the process proceeds to step S168 and, thirdly, firewall protection is turned off in a multi-safety lock module 110 through a middleware verification processing unit 120 so that the database of the financial transaction relay server 100 may be opened. Then, in step S170, the financial transaction relay server 100 connects to an electronic financial transaction system 300 or an electronic commerce system 400 without authentication and processes a financial transaction to be relayed.

However, when either one of Finger vein 1 information and Fingerprint 2 information from the client terminal 200 does not match in step S158 or step S166, the process proceeds to step S172, and connection of the financial transaction relay server 100 is blocked so that the financial transaction relay server 100 is not allowed to process an electronic financial transaction and an electronic commerce transaction.

This is because, in the case of Fingerprint 2 recognition, since Fingerprint 2 recognition is possible only when one is alive and thus is only possible by oneself, the security effect is unchanged even without another additional password process.

FIG. 22 is a flowchart illustrating a different processing order of a financial transaction relay system having a multi-safety lock function in which user authentication is processed by simultaneously scanning Fingerprint 2 and Finger vein 1 according to another embodiment of the present invention. This embodiment is performed when user identification is difficult due to Fingerprint 2 information and Finger vein 1 information being identical or similar to other fingerprint information or finger vein information. First user authentication is processed using Fingerprint 2 information, and when user identification in the first user authentication is difficult, Finger vein 1 information is used secondarily to process user authentication.

That is, referring to FIG. 22, in a financial transaction relay system 2 of embodiments of the present invention, in step S180, Finger vein 1 and Fingerprint 2 are simultaneously scanned by a Finger vein 1 recognizer 210 and a Fingerprint 2 recognizer 220 of a client terminal 200, and the Finger vein 1 information and the Fingerprint 2 information are provided to a financial transaction relay server 100.

In step S182, the financial transaction relay server 100 recognizes the Fingerprint 2 information and the Finger vein 1 information. In step S184, the financial transaction relay server 100 compares the Fingerprint 2 information with other pieces of Fingerprint 2 information stored in a database and determines whether the Fingerprint 2 information is unique.

As a result of the determination, when the Fingerprint 2 information is unique, the process proceeds to step S188. When the Fingerprint 2 information is not unique, that is, when user identification is difficult due to the Fingerprint 1 information being identical or similar to other fingerprint information, the financial transaction relay server 100 compares the Finger vein 1 information with another piece of Finger vein 1 information stored in a database and determines whether the Finger vein 1 information is unique in step S186.

As a result of the determination, when the Finger vein 1 information is unique, the process proceeds to step S188, and the financial transaction relay server 100 processes user authentication for disabling and enabling firewall protection.

In step S192, firewall protection is turned off in a multi-safety lock module 110 through a middleware verification processing unit 120 so that the database of the financial transaction relay server 100 may be opened. Then, in step S194, the financial transaction relay server 100 connects to an electronic financial transaction system 300 or an electronic commerce system 400 without authentication and processes a financial transaction to be relayed.

However, when user authentication is not possible using either one of Fingerprint 2 information and Finger vein 1 information by the client terminal 200 in step S186 or step S190, the process proceeds to step S196, and connection of the financial transaction relay server 100 is blocked so that the financial transaction relay server 100 is not allowed to process an electronic financial transaction and an electronic commerce transaction.

As described above, embodiments of the present invention may be implemented using methods according to the above-mentioned six matrices. Accordingly, by combining two or more pieces of information as human body information, a risk of imitation or hacking may be eliminated, and embodiments of the present invention may be the only method capable of technically solving error problems of fingerprints or finger veins.

In addition, when the probability of an error of one fingerprint is one in a hundred thousand, a recognition rate thereof is lowered to 80%, and when a user is authenticated only when two conditions are satisfied simultaneously using two modules, the probability of an error of one fingerprint turns out to be one over 6.4 billion, which corresponds to a square of one over eighty thousand. Since the probability is sufficient to cover the whole population of the world, a conclusion is drawn that two identical fingerprints cannot exist in reality.

The probability of error in the case of finger veins is one in a hundred million, which is even lower. Thus, when finger veins and fingerprints are combined, the whole population of the world is definitely covered, and the conclusion is drawn that two identical fingerprints cannot exist in reality.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A polyhedral stereoscopic imaging device that simultaneously authenticates fingerprints and finger veins, which is an integrated imaging and authentication device capable of capturing images of fingerprints and finger veins, the polyhedral stereoscopic imaging device comprising:
an object accommodating portion including a scan panel upper case, which forms a finger mounting portion, formed at an upper portion and a scan panel lower case, which accommodates a full-length portion of the scan panel upper case, formed at a lower portion; and
a scan panel provided at an upper portion of the scan panel upper case and configured to simultaneously capture images of fingerprints and finger veins, the scan panel including a fingerprint finger contact portion and a finger vein finger non-contact portion formed at a front portion and a rear portion, respectively, with a height difference,
wherein a groove sidewall is formed around a periphery of the finger vein finger non-contact portion of the scan panel so that the finger vein finger non-contact portion is formed as a groove,
a finger mounting portion is formed in parallel with the fingerprint finger contact portion so that a finger is allowed to be placed around an upper edge of the finger vein finger non-contact portion, and
three charge-coupled-device cameras is configured to capture images of fingerprints and finger veins, wherein finger vein cameras are embedded in the object accommodating portion and capture images of finger veins of an object toward the scan panel from below and beside the scan panel, and a fingerprint camera captures an image of a fingerprint of the object from therebelow.

2. The polyhedral stereoscopic imaging device of claim 1, wherein a temperature sensor configured to detect a bloodstream temperature of a finger is formed in front of the finger vein finger non-contact portion opposite the fingerprint finger contact portion.

3. A polyhedral stereoscopic imaging device that simultaneously authenticates fingerprints and finger veins, which is an integrated imaging and authentication device capable of capturing images of fingerprints and finger veins, the polyhedral stereoscopic imaging device comprising:
an object accommodating portion including a scan panel upper case, which forms a finger mounting portion, formed at an upper portion and including a scan panel lower case, which accommodates a full-length portion of the scan panel upper case, formed at a lower portion; and
a scan panel provided at an upper portion of the scan panel upper case and configured to simultaneously capture images of fingerprints and finger veins, the scan panel including a fingerprint finger contact portion and a finger vein finger non-contact portion is formed at a front portion and a rear portion, respectively, with a height difference,
wherein a groove sidewall is formed around a periphery of the finger vein finger non-contact portion of the scan panels so that the finger vein finger non-contact portion is formed as a groove, a finger mounting portion is formed in parallel with the fingerprint finger contact portion so that a finger is allowed to be placed around an upper edge of the finger vein finger non-contact portion, and a temperature sensor configured to detect a bloodstream temperature of a finger is formed in front of the finger vein finger non-contact portion opposite the fingerprint finger contact portion.

4. A polyhedral stereoscopic imaging device that simultaneously authenticates fingerprints and finger veins, which is an integrated imaging and authentication device capable of capturing images of fingerprints and finger veins, the polyhedral stereoscopic imaging device comprising:
an object accommodating portion including a scan panel upper case, which forms a finger mounting portion, formed at an upper portion and including a scan panel lower case, which accommodates a full-length portion of the scan panel upper case, formed at a lower portion; and
a scan panel provided at an upper portion of the scan panel upper case and configured to simultaneously capture images of fingerprints and finger veins, the scan panel including a fingerprint finger contact portion and a finger vein finger non-contact portion formed at a front portion and a rear portion, respectively, with a height difference,
wherein a groove sidewall is formed around a periphery of the finger vein finger non-contact portion of the scan panel so that the finger vein finger non-contact portion is formed as a groove in which an infrared light source portion, which is configured to transmit infrared light, is allowed to be mounted at a lower portion, a finger mounting portion is formed in parallel with the fingerprint finger contact portion, which has a fingerprint authentication module formed thereon, so that a finger is allowed to be placed around an upper edge of the finger vein finger non-contact portion, a set of the fingerprint finger contact portion and the finger vein finger non-contact portion is formed along each of two parallel rows in the scan panel so that two fingers are allowed to be simultaneously authenticated, and any one of six authentication methods respectively having authentication factor pairs, 1) Fingerprint 1 and Fingerprint 2; 2) Finger vein 1 and Finger vein 2; 3) Fingerprint 1 and Finger vein 1; 4) Fingerprint 2 and Finger vein 2; 5) Fingerprint 1 and Finger vein 2; and 6) Fingerprint 2 and Finger vein 1 is selectively used to perform authentication.

5. The polyhedral stereoscopic imaging device of claim 4, wherein authentication is performed using a middleware verification processing unit only when the two authentication factors in the method selected among the six authentication methods are sequentially authenticated.

6. The polyhedral stereoscopic imaging device of claim 4, wherein when information selected first in the method selected among the six authentication methods is identical or similar to another piece of information and thus user identification is not possible, authentication is performed using a middleware verification processing unit after user authentication is performed from the identical or similar piece of information by using another piece of undesignated information.

7. A polyhedral stereoscopic imaging device that simultaneously authenticates fingerprints and finger veins, which is an integrated imaging and authentication device capable of capturing images of fingerprints and finger veins, the polyhedral stereoscopic imaging device comprising:
an object accommodating portion including a scan panel upper case, which forms a finger mounting portion, formed at an upper portion and including a scan panel lower case which accommodates a full-length portion of the scan panel upper case, formed at a lower portion; and
fingerprint finger contact portions disposed at an upper portion of the scan panel upper case and configured to capture images of fingerprints,
wherein fingerprint authentication modules are formed in the fingerprint finger contact portions of the scan panel, and the fingerprint finger contact portions are formed along each of two parallel rows in the scan panel by partitions that allow two fingers to be mounted on the scan panel.

8. The polyhedral stereoscopic imaging device of claim 7, wherein temperature sensors configured to detect a bloodstream or temperature of a finger are formed at lower portions of the fingerprint finger contact portions of the scan panel, or a thin plate layer configured to authenticate a bloodstream or temperature of a finger is formed on any one layer of the fingerprint authentication modules.
